(19) United States
(12) Patent Application Publication
(10) Pub. No.: US 2024/0172795 A1
(43) Pub. Date: May 30, 2024

(54) HEATING MECHANISM AND AEROSOL GENERATION DEVICE

(71) Applicant: SHENZHEN FIRST UNION TECHNOLOGY CO., LTD., Shenzhen City, Guangdong Province (CN)

(72) Inventors: ZHIMING LU, Shenzhen City, Guangdong Province (CN); ZHONGLI XU, Shenzhen City, Guangdong Province (CN); YONGHAI LI, Shenzhen City, Guangdong Province (CN)

(21) Appl. No.: 18/282,992

(22) PCT Filed: Mar. 18, 2022
(86) PCT No.: PCT/CN2022/081693

§ 371 Date: Sep. 19, 2023

(30) Foreign Application Priority Data
Mar. 19, 2021 (CN) 202120583958.3

(51) Int. Cl. A24F 40/46; H05B 3/00

(52) U.S. Cl. CPC A24F 40/46; H05B 3/0052

(57) ABSTRACT

A heating mechanism and aerosol generation device are provided. The heating mechanism includes a chamber; a heater; and a first end cap, connected to an end of the heater, where the first end cap includes an inner cylinder at least partially extending into an interior of the chamber. The inner cylinder has a closed end and an opposite open end, and the open end of the inner cylinder is configured to abut against the aerosol product when the aerosol product is received within the chamber, so that a substantially closed space is formed between the closed end and the open end. Through this application, after an aerosol generation product is inserted into the heating mechanism, a closed chamber may be formed on an end cap.

### CROSS-REFERENCE TO RELATED APPLICATIONS

This application claims priority to Chinese Patent Application No. 202120583958.3, filed with the China National Intellectual Property Administration on Mar. 19, 2021 and entitled “HEATING MECHANISM AND AEROSOL GENERATION DEVICE”, which is incorporated herein by reference in its entirety.

### TECHNICAL FIELD

This application relates to the technical field of cigarette devices, and in particular, to a heating mechanism and an aerosol generation device.

### BACKGROUND

During use of smoking objects such as a cigarette or a cigar, tobaccos are burnt to generate vapor. A product that releases compounds without burning has been tried to provide an alternative for the objects that burn the tobaccos. An example of the products is a heat-not-burn product, which releases compounds by heating the tobaccos rather than burning the tobaccos.

The existing cigarette device generally uses a bottom air intake manner. Problems in this manner is that a negative pressure inside the cigarette is small during inhalation, which is not conducive to the discharge of an aerosol, so that an amount of vapor is small and inhalation experience of a user is not high. In addition, if parts are arranged under a heater, condensate or residues can easily accumulate on the parts, which is not conducive to the cleaning of cigarette device and causes damage to the parts.

### SUMMARY

This application provides a heating mechanism and an aerosol generation device, to resolve the problems of small amount of vapor and unfavorable cleaning when an existing cigarette device uses a bottom air intake manner.

This application provides a heating mechanism, including:
a chamber;
a heater, constructed to be tubular extending in an axial direction of the chamber and surrounding the chamber, where the heater is configured to heat an aerosol generation product removably received in the chamber to generate an aerosol for inhalation; and
a first end cap, connected to an end of the heater, where the first end cap includes an inner cylinder at least partially extending into an interior of the chamber; and

The inner cylinder has a closed end and an opposite open end, and the open end of the inner cylinder is configured to abut against the aerosol product when the aerosol product is received within the chamber, so that a substantially closed space is formed between the closed end and the open end.

This application further provides an aerosol generation device. The aerosol generation device includes a housing, a battery core, and the heating mechanism.

The battery core and the heating mechanism are both arranged in the housing.

According to the heating mechanism and the aerosol generation device of this application, a closed chamber may be formed on an end cap after an aerosol generation product is inserted into the heating mechanism; When the inserted aerosol generation product is heated, the closed chamber may store an aerosol generated by heating, so that a smoke concentration can be increased when a user inhales, thereby improving inhalation experience of the user. In addition, the closed chamber may collect condensate and residues to facilitate cleaning of the aerosol generation device.

### BRIEF DESCRIPTION OF THE DRAWINGS

One or more embodiments are exemplarily described with reference to the corresponding figures in the accompanying drawings, and the exemplary descriptions are not to be construed as limiting the embodiments. Elements/modules and steps in the accompanying drawings that have same reference numerals are represented as similar elements/modules and steps, and unless otherwise particularly stated, the figures in the accompanying drawings are not drawn to scale.

FIG. 1 is a schematic diagram of an aerosol generation device according to an implementation of this application.

FIG. 2 is a cross-sectional view of an aerosol generation device according to an implementation of this application.

FIG. 3 is a partially enlarged schematic diagram of FIG. 2.

FIG. 4 is a schematic exploded view of an aerosol generation device according to an implementation of this application.

FIG. 5 is a schematic exploded view of a heating mechanism in an aerosol generation device according to an implementation of this application.

FIG. 6 is a schematic diagram of a heater according to an implementation of this application;

FIG. 7 is a schematic diagram of an upper end cap according to an implementation of this application.

FIG. 8 is a schematic diagram of a lower end cap according to an implementation of this application.

FIG. 9 is a schematic diagram of a lower end cap from another perspective according to an implementation of this application.

### DETAILED DESCRIPTION

For ease of understanding of this application, this application is described below in more detail with reference to the accompanying drawings and specific implementations. It should be noted that when an element is expressed as “being fixed to” another element, the element may be directly on the another element, or one or more intermediate elements may exist between the element and the another element. When one element is expressed as “being connected to” another element, the element may be directly connected to the another element, or one or more intermediate elements may exist between the element and the another element. The terms “upper”, “lower”, “left”, “right”, “inner”, “outer”, and similar expressions used in this specification are merely used for an illustrative purpose.

Unless otherwise defined, meanings of all technical and scientific terms used in this specification are the same as that usually understood by a person skilled in the art to which this application belongs. The terms used in this specification of this application are merely intended to describe objectives of the specific implementations, and are not intended to limit this application. A term “and/or” used in this specification includes any or all combinations of one or more related listed items.

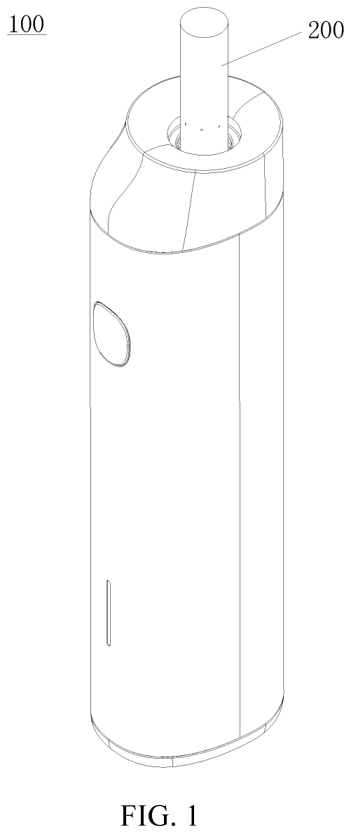

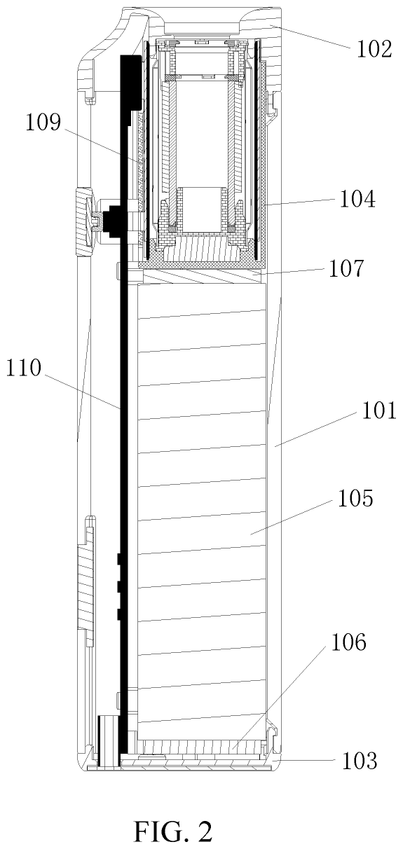

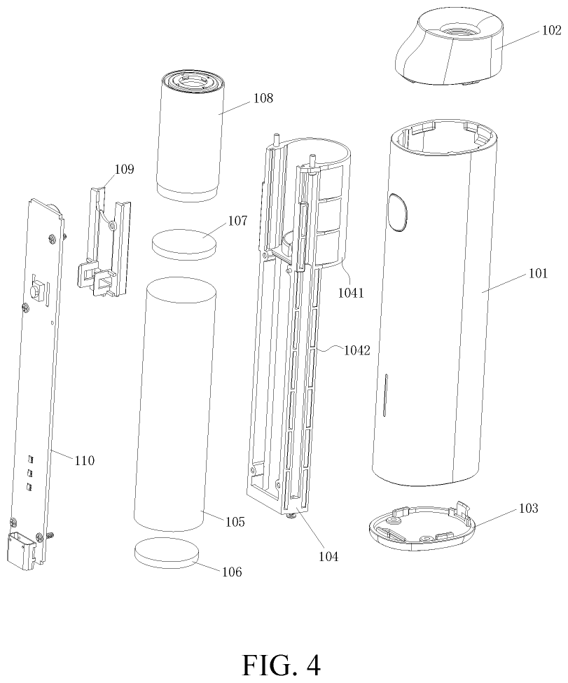

As shown in FIG. 1, FIG. 2, and FIG. 4, implementations of this application provide an aerosol generation device 100, which includes a housing, a support 104, a battery core 105, a washer 106, a heat insulation sheet 107, a heating mechanism 108, a fixing plate 109, and a circuit board 110 accommodated in the housing.

The housing includes a body 101, an upper cap 102, and a bottom cap 103. The body 101 is substantially tubular with openings at both ends, the upper cap 102 is engaged with an upper end of the body 101, the bottom cap 103 is engaged with a lower end of the body 101, thereby forming an accommodating space to accommodate the support 104, the battery core 105, the washer 106, the heat insulation sheet 107, the heating mechanism 108, the fixing plate 109, and the circuit board 110.

A through hole is arranged on the upper cap 102. An aerosol generation product 200 is removably received in a chamber of the heating mechanism 108 within the housing through the through hole, the heating mechanism 108 may heat the aerosol generation product to generate an inhalable aerosol, and a user can inhale the aerosol through a mouthpiece part exposed outside the through hole. The aerosol generation product 200 may refer to the prior art, and details are not described herein.

The fixing plate 109 is fixed to the support 104, and the fixing plate 109 and the support 104 can divide the accommodating space in the housing into a first accommodating space and a second accommodating space isolated from each other in a longitudinal direction of the aerosol generation device; and the heating mechanism 108 is accommodated in the first accommodating space, and the battery core 105 is accommodated in the second accommodating space. A support portion 1042 extending in a longitudinal direction of the aerosol generation device and an accommodating portion 1041 formed on the support portion 1042 are arranged on the support 104; after the fixing plate 109 is fixed to the support 104, the fixing plate and the accommodating portion 1041 form the first accommodating space open at one end and closed at another end to accommodate the heating mechanism 108; and the battery core 105 is arranged on a side of the support portion 1042 and is located below the accommodating portion 1041. It should be noted that in another example, that the fixing plate 109 is integrally formed with the support 104 is also feasible; and or similarly, that one or more separating plates are configured to divide space in the housing into a first accommodating space and a second accommodating space isolated from each other in a longitudinal direction of the aerosol generation device is also feasible.

The battery core 105 supplies power for operating the aerosol generation device 100. For example, the battery core 105 may supply power to heat the heater 1085. In addition, the battery core 105 may supply power for operating another element provided in the aerosol generation device 100. The battery core 105 may be a rechargeable battery or a disposable battery. The battery core 105 may be, but is not limited to, a lithium iron phosphate (LiFePO4) battery. For example, the battery core 105 may be a lithium cobaltate (LiCoO2) battery or a lithium titanate battery.

The circuit board 110 is fixed to the support portion 1042. The circuit board 110 may control overall operations of the aerosol generation device 100. The circuit board 110 not only controls operations of the battery core 105 and the heater 1085, but also controls operations of another element in the aerosol generation device 100. For example, the circuit board 110 obtains temperature information of the heater 1085 that is sensed by a temperature sensor, and controls, based on the information, power supplied to the heater 1085 by the battery core 105.

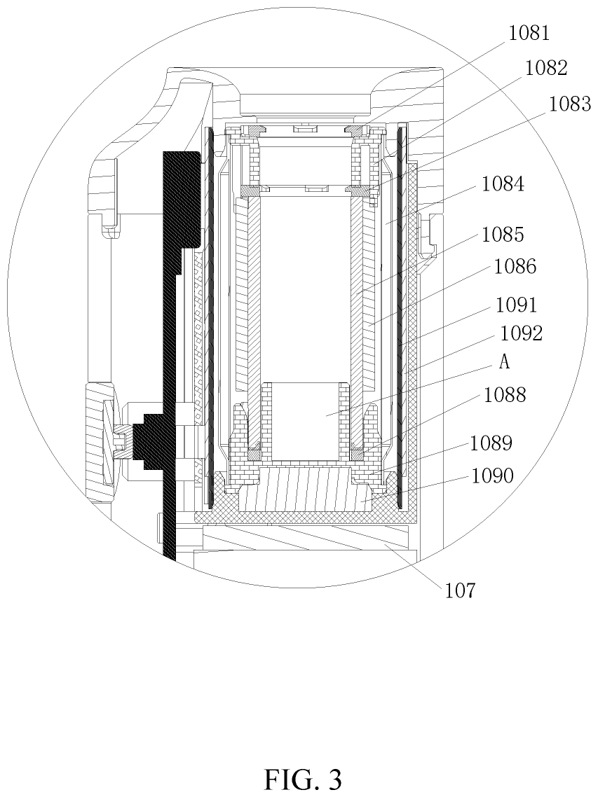

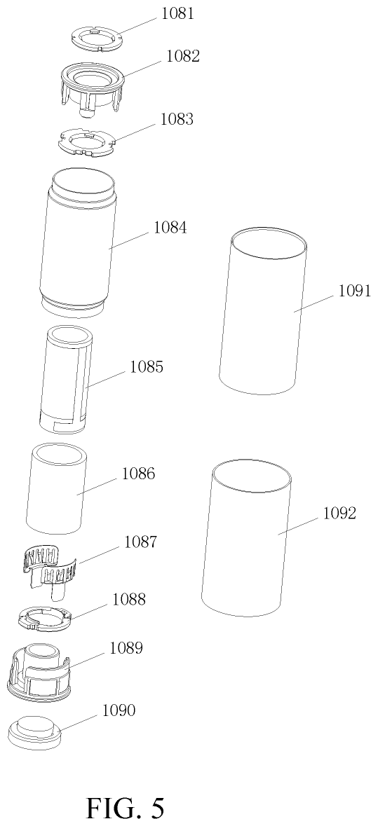

As shown in FIG. 3 and FIG. 5, the heating mechanism 108 includes a clamping member 1081, an upper end cap 1082, a first seal member 1083, an insulator 1084, a heater 1085, a first heat insulation member 1086, an electrode connecting member 1087, a second seal member 1088, a lower end cap 1089, a heat insulation pad 1090, a second heat insulation member 1091 and a sleeve 1092.

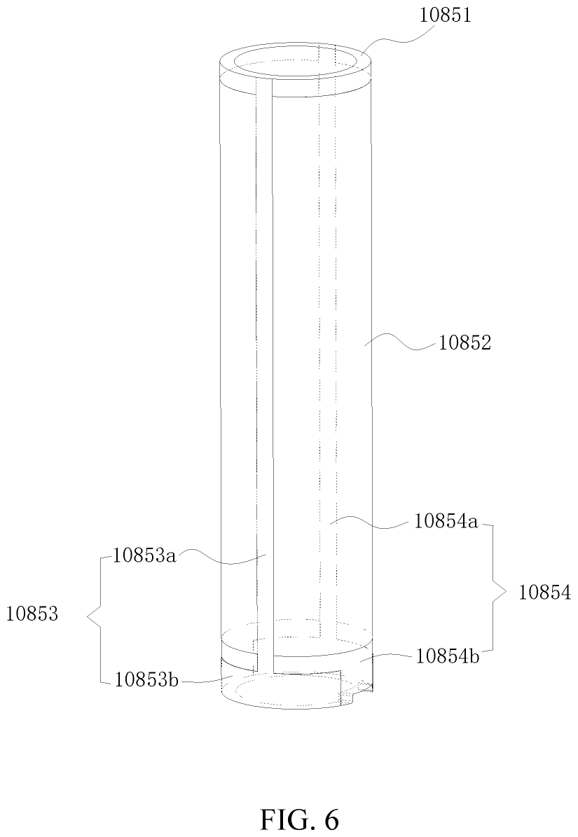

The heater 1085 is configured to generate infrared rays to radiate and heat the aerosol generation product 200 received in the chamber. As shown in FIG. 6, the heater 1085 includes:
abase body 10851, constructed as a tube extending in an axial direction of the chamber and surrounding the chamber.

Specifically, the base body 10851 includes a first end, a second end, and a surface extending between the first end and the second end. The base body 10851 may be in a shape of a cylinder, a prism, or another column. Preferably, the base body 10851 is in a shape of a cylinder, and a cylindrical hole extending through a middle part of the base body 10851 forms at least a part of the chamber, where an inner diameter of the hole is slightly greater than an outer diameter of the aerosol generation product 200. The base body 10851 may be made of a material that is high temperature-resistant and transparent, such as quartz glass, ceramic, or mica, or may be made of a material having a high infrared transmittance.

An infrared electrothermal coating 10852 is formed on the surface of the base body 10851. The infrared electrothermal coating 10852 may be formed on an outer surface of the base body 10851, or may be formed on an inner surface of the base body 10851. The infrared electrothermal coating 10852 receives electric power to generate heat, and then generates infrared rays of a certain wavelength, such as 8 m to 15 m far infrared rays. When a wavelength of the infrared rays matches an absorption wavelength of the aerosol-forming substrate, energy of the infrared rays is easily absorbed by the aerosol-forming substrate.

A conductive element includes a first electrode 10853 and a second electrode 10854 spaced apart on the base body 10851 and is configured to feed the electric power to the infrared electrothermal coating 10852. In this example, both the first electrode 10853 and the second electrode 10854 are conductive coatings, the conductive coating may be a metal coating, a conductive tape, or the like, and the metal coating may be made of silver, gold, palladium, platinum, copper, nickel, molybdenum, tungsten, niobium, or an alloy material of the foregoing metal. In this example, the first electrode 10853 and the second electrode 10854 are symmetrically arranged along a central shaft of the base body 10851. The first electrode 10853 includes a coupling electrode 10853b and a stripline electrode 10853a. The second electrode 10854 includes a coupling electrode 10854b and a stripline electrode 10854a. The coupling electrode 10853b and the coupling electrode 10854b do not contact the infrared electrothermal coating 10852. The stripline electrode 10853a and the stripline electrode 10854a at least partially contact the infrared electrothermal coating 10852 to form an electrical connection. The coupling electrode 10853b and the coupling electrode 10854b are connected to the battery core 105 through the electrode connecting member 1087.

It should be noted that an infrared transmitter formed by the infrared electrothermal coating 10852, the first electrode 10853, and the second electrode 10854 is not limited to the example in FIG. 6. In another example, the infrared transmitter may be formed by a thermal excited infrared radiation layer, or may be constructed by a thin film wound on the base body 10851. It should be further noted that, in another example, the heater 1085 is not limited to an infrared heating mode, and may alternatively be a resistance heating mode, an electromagnetic heating mode, and the like.

The upper end cap 1082 is sleeved on a first end of the base body 10851, the lower end cap 1089 is sleeved on a second end of the base body 10851, and the insulator 1084 is sleeved on the base body 10851 in a radial direction of the chamber. The upper end cap 1082 and the lower end cap 1089 are made of insulating, high-temperature-resistant and heat-insulating materials. The insulator 1084 has a double-layer tube arranged in the radial direction of the chamber, and the double-layer tube may be sealed and filled with gas or evacuated.

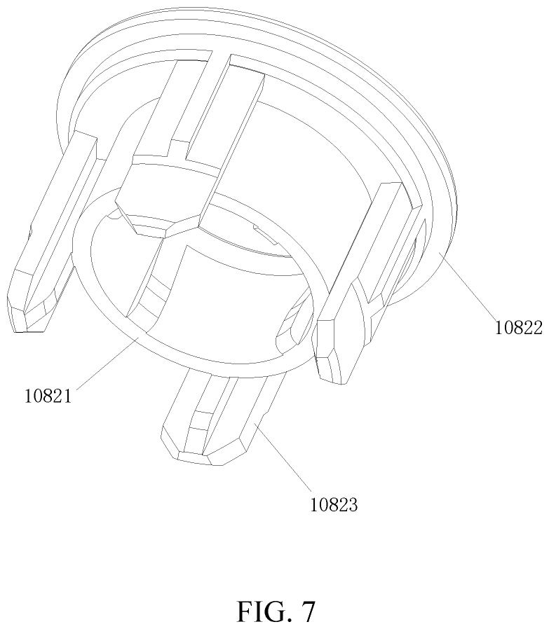

As shown in FIG. 7, the upper end cap 1082 includes a hollow tube 10821, a protruding portion 10822 extending from an end of the hollow tube 10821 in the radial direction of the chamber, and a holding portion 10823 extending from an axial direction of the protruding portion 10822. When the upper end cap 1082 is sleeved on the base body 10851, the holding portion 10823 abuts against an outer surface of the base body 10851 to hold a first end portion of the base body 10851. An end portion of the insulator 1084 may abut against the protruding portion 10822. As can be seen from the figure, two opposite surfaces of the holding portion 10823 in the radial direction have radially extending bumps. In this way, when the upper end cap 1082 is sleeved on the first end of the base body 10851, the bump on a surface abuts against the outer surface of the base body 10851; and when the end portion of the insulator 1084 abuts against the protruding portion 10822, the bump on another surface abuts against an inner surface of the insulator 1084.

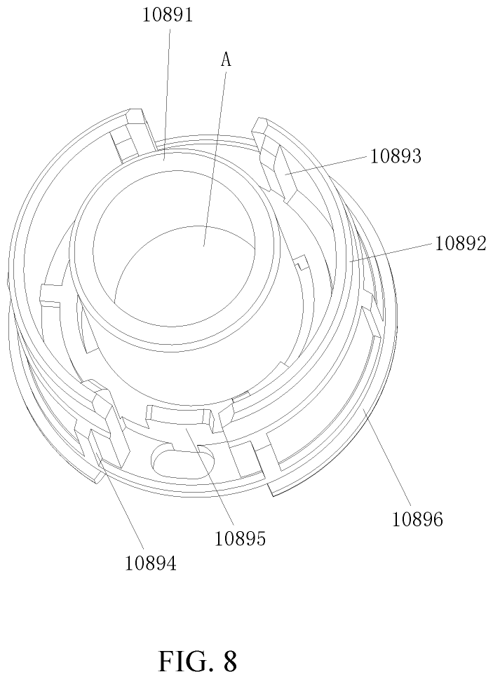

As shown in FIG. 8, the lower end cap 1089 includes an inner cylinder 10891 and an outer cylinder 10892, and the base body 10851 is sleeved between an outer wall of the inner cylinder 10891 and an inner wall of the outer cylinder 10892.

The inner cylinder 10891 has a closed end and an opposite open end; and when the aerosol generation product 200 is received in the chamber, the aerosol generation product 200 abuts against the open end of the inner cylinder 10891, so that a closed chamber A is formed between the closed end and the open end. The closed chamber A may store an aerosol generated by heating, so that a smoke concentration can be increased when a user inhales, thereby improving inhalation experience of the user. In addition, the closed chamber A may collect condensate and residues to facilitate cleaning of the aerosol generation device. When the user inhales, an airflow flows from the through hole of the upper cap 102 and flows along a gap between the aerosol generation product 200 and an inner surface of the base body 10851 to a bottom end of the aerosol generation product 200, thereby forming an airflow flow path. Due to the arrangement of the closed end of the inner cylinder 10891, when the lower end cap 1089 is sleeved on the second end of the base body 10851, the second end of the base body 10851 is closed, and the heating mechanism 108 is accommodated in the first accommodating space. In this way, the closed end of the inner cylinder 10891 and the accommodating portion 1041 of the support 104 increase a thermal conduction distance between a hot air in the chamber and the battery core 105, and avoid hazards such as fire and explosion caused by an excessive temperature of the battery core 105.

In conjunction with FIG. 3, a position of the second end of the base body 10851 is between the closed end and the open end in the axial direction of the chamber. That is to say, part of the closed chamber A may be located outside a heating zone.

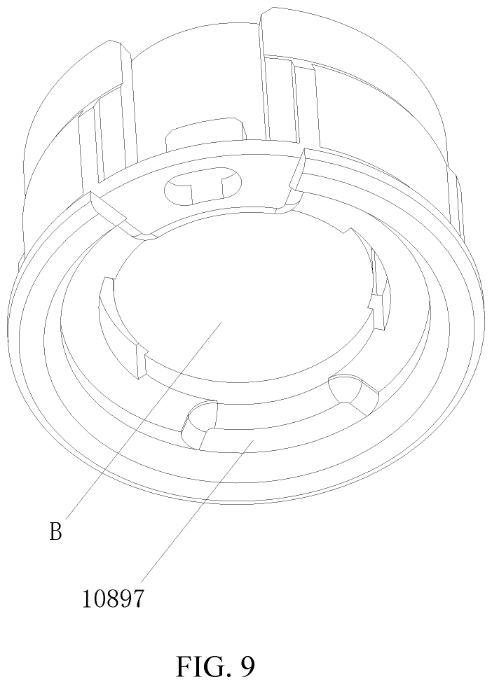

In conjunction with FIG. 3 and FIG. 9, the outer cylinder 10892 has a proximal end (viewing angle of the figure shown in FIG. 8) and a distal end; a recessed chamber B is formed between the proximal end of the outer cylinder 10892 and the closed end of the inner cylinder 10891 in an axial direction of the chamber; and part of the heat insulation pad 1090 is accommodated in the recessed chamber. The heat insulation pad 1090 may be made of common thermal insulation materials, such as the aerogel, and the heat insulation pad 1090 matches a shape of the recessed chamber B. The heat insulation pad 1090 may further prevent the temperature of the battery core 105 from being excessively high. Further, a plurality of bumps 10897 arranged at intervals and extending toward the heat insulation pad 1090 are arranged in the recessed chamber B, and the heat insulation pad 10897 abuts against the bumps 1090. The plurality of bumps 10897 may form a cavity between the heat insulation pad 1090 and the closed end, and further promote heat insulation through a low thermal conductivity of the air in the cavity. Still referring to FIG. 2, a heat insulation sheet 107 may alternatively be arranged between the battery core 105 and the accommodating portion 1041 to further prevent the temperature of the battery core 105 from being excessively high. The material of the heat insulation sheet 107 may refer to the heat insulation pad 1090. The washer 106 is arranged between the battery core 105 and the bottom cap 103, so that the battery core 105 is held on the washer 106.

Further, a plurality of abutting portions 10894 extending toward the insulator 1084 in a circumferential direction are arranged on the outer wall of the outer cylinder 10892, and an end portion of the outer cylinder 10892 has a protruding portion 10896 extending in the radial direction of the chamber. The arrangement of the abutting portions 10894 and the protruding portion 10896 facilitates assembly with the insulator 1084, so that the end portion of the insulator 1084 may abut against the protruding portion 10896. A plurality of spaced holding portions 10893 are further arranged on the inner wall of the outer cylinder 10892. The holding portions 10893 extend from the inner wall of the outer cylinder 10892 toward the inner cylinder 10891. When the base body 10851 is sleeved on the lower end cap 1089, the holding portions 10893 abut against the outer surface of the base body 10851 to hold a second end portion of the base body 10851. A circumferential stop portion for preventing the base body 10851 from rotating is further arranged on the lower end cap 1089. The circumferential stop portion includes a positioning protrusion 10895 protruding toward a side of the base body 10851 on the lower end cap 1089. A positioning notch correspondingly matching the positioning protrusion 10895 is arranged on a tube wall of the base body 10851. When the base body 10851 is sleeved on the lower end cap 1089, the positioning protrusion 10895 correspondingly matches the positioning notch to prevent the base body 10851 from rotating circumferentially relative to the lower end cap 1089. A through hole for leading out of the electrode connector 1087 is further arranged on the lower end cap 1089.

Further, a first seal member 1083 may be arranged between the upper end cap 1082 and the first end portion of the base body 10851, and a second seal member 1088 may be arranged between the lower end cap 1089 and the second end portion of the base body 10851, which can prevent aerosol generated inside the base body 10851 from entering a space between the outer surface of the base body 10851 and the insulator 1084 and corroding the infrared electrothermal coating 10852 and the conductive coatings on the outer surface of the base body 10851, thereby improving working reliability of the heater 1085. The clamping member 1081 is arranged on the upper end cap 1082 to facilitate clamping or positioning of the aerosol generation product 200.

After the base body 10851, the upper end cap 1082, the lower end cap 1089, and the insulator 1084 are assembled, since two ends of the insulator 1084 abut against the protruding portion 10822 and the protruding portion 10896 respectively, a roughly sealed enclosed compartment may be formed among the outer surface of the base body 10851, the upper end cap 1082, the lower end cap 1089, and the insulator 1084. A heat insulation member 1086 may be arranged in the enclosed chamber, to reduce heat of the heater 1085 that is transferred to the outside of the aerosol generation device 100.

In this example, the first heat insulation member 1086 includes an aerogel layer wrapped on the outer surface of the base body 10851. The aerogel layer can reduce radiation heat transfer of the heater, and the enclosed compartment can reduce air flow inside and outside the enclosed chamber to prevent aerogel powder from falling. An extension length of a sealing space in the axial direction of chamber is greater than an extension length of the aerogel layer in the axial direction of chamber. In this way, the sealing space can cover the aerogel layer, which is conducive to heat insulation. Further, a gap between the aerogel layer and the heat insulation tube extends in the axial direction of chamber, which ensures that an aerogel is fluffy and the heat insulation effect is good. In addition, air in the gap can further prevent heat from being transferred to the outside of the aerosol generation device 100.

The second heat insulation member 1091 and the sleeve 1092 are further sleeved in the radial direction of the chamber. The second heat insulation member 1091 may refer to the description of the first heat insulation member 1086, and after the sleeve 1092 is sleeved, the heating mechanism 108 is accommodated in the first accommodating space.

It should be noted that the specification of this application and the accompanying drawings thereof illustrate preferred embodiments of this application. However, this application may be implemented in a plurality of different forms, and is not limited to the embodiments described in this specification. These embodiments are not intended to be an additional limitation on the content of this application, and are described for the purpose of providing a more thorough and comprehensive understanding of the content disclosed in this application. Moreover, the foregoing technical features are further combined to form various embodiments not listed above, and all such embodiments shall be construed as falling within the scope of this application. Further, a person of ordinary skill in the art may make improvements or modifications according to the foregoing descriptions, and all the improvements and modifications shall fall within the protection scope of the appended claims of this application.

1: A heating mechanism, comprising:
a chamber;
a heater, constructed to be tubular extending in an axial direction of the chamber and surrounding the chamber, wherein the heater is configured to heat an aerosol generation product removably received in the chamber to generate an aerosol for inhalation; and
a first end cap, connected to an end of the heater, wherein the first end cap comprises an inner cylinder at least partially extending into an interior of the chamber; and
the inner cylinder has a closed end and an opposite open end, and the open end of the inner cylinder is configured to abut against the aerosol generation product when the aerosol generation product is received within the chamber, so that a substantially closed space is formed between the closed end and the open end.

2: The heating mechanism according to claim 1, wherein the first end cap further comprises an outer cylinder and a connection portion extending from an inner wall of the outer cylinder to an outer wall of the inner cylinder, and an end of the heater is positioned between the inner wall of the outer cylinder and the outer wall of the inner cylinder and abuts against the connection portion.

3: The heating mechanism according to claim 1, wherein a position of the end of the heater is between the closed end and the open end in the axial direction of the chamber.

4: The heating mechanism according to claim 1, wherein the outer cylinder has a proximal end and a distal end, and a recessed chamber is formed between the proximal end of the outer cylinder and the closed end of the inner cylinder in the axial direction of the chamber; and
the heating mechanism further comprises a heat insulation pad, and at least part of the heat insulation pad is accommodated in the recessed chamber.

5: The heating mechanism according to claim 4, wherein a plurality of bumps arranged at intervals and extending toward the heat insulation pad are arranged in the recessed chamber, and the heat insulation pad abuts against the bumps.

6: The heating mechanism according to claim 1, further comprising a second end cap held at another end of the heater.

7: The heating mechanism according to claim 6, further comprising an insulator located outside the heater in a radial direction, wherein an end of the insulator abuts against the first end cap, and another end of the insulator abuts against the second end cap.

8: The heating mechanism according to claim 1, wherein the heater comprises:
a base body, having a surface; and
an infrared transmitter, arranged on the surface, wherein the infrared transmitter is configured to generate infrared rays to radiate and heat an aerosol-forming substrate received in the chamber.

9: An aerosol generation device, comprising a housing, a battery core, and the heating mechanism according to claim 1, wherein:
the battery core and the heating mechanism are both arranged in the housing.

10: The aerosol generation device according to claim 9, further comprising a separating plate arranged in the housing, wherein:
the separating plate is configured to divide a space in the housing into a first accommodating space and a second accommodating space isolated from each other in a longitudinal direction of the aerosol generation device; and
the heating mechanism is arranged in the first accommodating space, and the battery core is arranged in the second accommodating space.

11: The aerosol generation device according to claim 10, further comprising a heat insulation sheet arranged between the separating plate and the battery core.
